(19) United States
(12) Patent Application Publication
(10) Pub. No.: US 2018/0226682 A1
(43) Pub. Date: Aug. 9, 2018

(54) COMPOSITE ELECTROLYTE MEMBRANE, FABRICATION METHODS AND APPLICATIONS OF SAME

(71) Applicants: University of California, Los Angeles, Los Angeles, CA (US); Ford Cheer International Limited, Road Town (VG)

(72) Inventors: Yunfeng Lu, Culver City, CA (US); Jianguo Xu, Walnut, CA (US); Fang Liu, Los Angeles, CA (US)

(21) Appl. No.: 15/888,223

(22) Filed: Feb. 5, 2018

Related U.S. Application Data
(60) Provisional application No. 62/455,752, filed on Feb. 7, 2017.
(60) Provisional application No. 62/455,800, filed on Feb. 7, 2017.

(51) Int. Cl. H01M 10/0565; H01M 10/0525; H01M 10/0567; H01M 10/056

(52) U.S. Cl. CPC H01M 10/0565; H01M 10/0525; H01M 10/0567; H01M 10/056; H01M 2300/0028; H01M 2300/0091; H01M 2300/0085; H01M 2300/0082; H01M 2300/0071; H01M 2220/20

(57) ABSTRACT

A composite electrolyte membrane usable for ionic conductor for an electrochemical device contains a support matrix adapted to function as at least one of a mechanical support, a fire retardant, and an electronic blocking layer; a material of metal-organic frameworks (MOF), the MOFs being a class of crystalline porous solids constructed from metal cluster nodes and organic linkers, where the MOFs are incorporated into the support matrix by coating, lamination, physical mixing and press, in situ growth or polymerization; and a liquid electrolyte impregnated the porous MOFs and adapted to function as an electrolyte modulator to immobilize anions and liberate cations.

### CROSS-REFERENCE TO RELATED PATENT APPLICATIONS

This application claims priority to and the benefit of, pursuant to 35 U.S.C. § 119(e), U.S. Provisional Patent Application Ser. Nos. 62/455,752 and 62/455,800, both filed Feb. 7, 2017, which are incorporated herein in their entireties by reference.

### FIELD

This present invention relates generally to electrochemical technologies, and more particularly to a composite electrolyte membrane and fabrication methods and applications of the same.

### BACKGROUND

The background description provided herein is for the purpose of generally presenting the context of the present invention. The subject matter discussed in the background of the invention section should not be assumed to be prior art merely as a result of its mention in the background of the invention section. Similarly, a problem mentioned in the background of the invention section or associated with the subject matter of the background of the invention section should not be assumed to have been previously recognized in the prior art. The subject matter in the background of the invention section merely represents different approaches, which in and of themselves may also be inventions. Work of the presently named inventors, to the extent it is described in the background of the invention section, as well as aspects of the description that may not otherwise qualify as prior art at the time of filing, are neither expressly nor impliedly admitted as prior art against the present invention.

Development of rechargeable batteries has been under intensive investigations due to their ubiquitous applications in portable electronics. While developing next-generation battery systems with higher power capability, longer cycle life and superior safety is still challenging and demanding since these properties are desirable features in applications of power supplies for vehicles, such as hybrid electric vehicles (HEV), battery electric vehicles (BEV), plug-in HEVs, and extended-range electric vehicles (EREV). Furthermore, the driving-range anxiety for customers of electric vehicles require the battery packages with higher gravimetric and volumetric energy density, which are considerably restricted by current electrode and electrolyte electrochemistry.

For instance, the lithium metal anode, which possesses highest theoretical gravimetric capacity of 3860 mAh g⁻¹ and lowest SHE (standard hydrogen electrode) potential (−3.04 V vs H₂/H⁺), rendering the intriguing possibility of boosting overall energy density. However, it's been excluded from the secondary lithium battery systems due to its unrestricted consumption of electrolyte when directly exposing lithium to liquid electrolyte, therefore leading to poor Coulombic efficiency and severe safety issue. On the other hand, despite high conductivity of conventional liquid electrolyte, on the order of 10⁻² S/cm, it suffers from low cationic transference number (0.2-0.4) as well as parasitic reactions, which give rise to unsatisfactory power density and calendar battery life. The disadvantageous aspect of traditional liquid electrolyte has been persistently overlapped due to the lack of transforming additive to effectively modulate the ionic chemistry of existing electrolytes.

Therefore, a heretofore unaddressed need exists in the art to address the aforementioned deficiencies and inadequacies.

### SUMMARY

In one aspect, this invention relates to a composite electrolyte membrane comprising an alkali metal liquid electrolyte, a support matrix and metal-organic frameworks (MOFs) material that is presented as an ionic conductor for electrochemical devices. The support matrix serves either for mechanical support, fire retardant or electronic blocking layer. The liquid electrolyte impregnated porous metal-organic framework functions as electrolyte modulator to immobilize anion as well as to liberate cation. The enhanced cationic transport number benefits not only electrochemical performances but also improve the thermal stability. In certain configuration, the combination approaches of the support matrix and the MOFs can be coating, lamination, physical mixing and press, in situ growth or polymerization.

In another aspect of the invention, a composite electrolyte membrane usable for ionic conductor for an electrochemical device includes a support matrix adapted to function as at least one of a mechanical support, a fire retardant, and an electronic blocking layer; a material of MOFs, the MOFs being a class of crystalline porous solids constructed from metal cluster nodes and organic linkers, wherein the MOFs are incorporated into the support matrix by coating, lamination, physical mixing and press, in situ growth or polymerization; and a liquid electrolyte impregnated the porous MOFs and adapted to function as an electrolyte modulator to immobilize anions and liberate cations.

In one embodiment, a weight ratio of the MOFs to the liquid electrolyte ranges from about 10:1 to about 1:1000.

In one embodiment, the MOFs have open metal sites (OMS) created by activating pristine MOFs to remove guest molecules or partial ligands thereof.

In one embodiment, through introducing or impregnating the liquid electrolyte, the polarized OMS is capable of bonding anions, thereby forming anion-decorated ion channels, wherein the resulting electrolyte structure is a negatively charged framework that facilitates fast movements of cations within the channels.

In one embodiment, the electrolyte structure is formed by spontaneously binding electrolyte anions including ClO₄⁻, BF₄—, PF₆⁻, TFSI⁻ (bis(trifluoromethane)sulfonimide), FSI⁻ (bis(fluorosulfonyl)imide), or the like to the OMS of the MOFs, wherein the binding constructs negatively charged channels in the pores of the MOFs, which enables fast conduction of solvated ions.

In one embodiment, each MOF contains metal centers from the p-block or the d-block, and one or more ligands of benzene-1,3,5-tricarboxylic acid (BTC), benzene-1,4-dicarboxylic acid (BDC), azobenzene-4,4′-dicarboxylic acid (ADC) and isonicotinic acid (IN).

In one embodiment, the MOF comprises Cu₃(BTC)₂, Al₃O(OH)(BTC)₂, Fe₃O(OH)(BTC)₂, Mn₃(BDC)₃, (In₃O)(OH)(ADC)₂(IN)₂, or Zirconium-based MOF including UiO-66, UiO-67, UiO-66-NH₂, UiO-66-OH, or UiO-66-Br.

In one embodiment, the liquid electrolyte comprises one or more non-aqueous solvents and metal salts dissolved in the one or more non-aqueous solvents.

In one embodiment, the one or more non-aqueous solvents are selected to match the surface properties of the MOF material.

In one embodiment, the metal salts are selected to have anions with desired sizes, which depends, at least in part, upon the MOF material, wherein the anion sizes are selected to ensure that the salts to infiltrate into at least some of the pores of the MOF, and then become immobilized therein to form the ionic conducting channels.

In one embodiment, the non-aqueous liquid electrolyte solvents comprise ethylene carbonate (EC), propylene carbonate (PC), vinylene carbonate (VC), fluoroethylene carbonate (FEC), butylene carbonate (BC), dimethyl carbonate (DMC), diethyl carbonate (DEC), ethylmethyl carbonate (EMC), methylpropyl carbonate (MPC), butylmethyl carbonate (BMC), ethylpropyl carbonate (EPC), dipropyl carbonate (DPC), cyclopentanone, sulfolane, dimethyl sulfoxide, 3-methyl-1,3-oxazolidine-2-one, γ-butyrolactone, 1,2-di-ethoxymethane, tetrahydrofuran, 2-methyltetrahydrofuran, 1,3-dioxolane, methyl acetate, ethyl acetate, nitromethane, 1,3-propane sultone, γ-valerolactone, methyl isobutyryl acetate, 2-methoxyethyl acetate, 2-ethoxyethyl acetate, diethyl oxalate, an ionic liquid, chain ether compounds including at least one of gamma butyrolactone, gamma valerolactone, 1,2-dimethoxyethane and diethyl ether, cyclic ether compounds including at least one of tetrahydrofuran, 2-methyltetrahydrofuran, 1,3-dioxolane and dioxane, or a combination thereof.

In one embodiment, the metal salts comprise one or more of a lithium (Li) salt, a sodium (Na) salt, a magnesium (Mg) salt, and a zinc (Zn) salt.

In one embodiment, the lithium salt includes lithium hexafluorophosphate, lithium hexafluoroarsenate, lithium bis(trifluoromethlysulfonylimide) (LiTFSI), lithium bis(trifluorosulfonylimide), lithium trifluoromethanesulfonate, lithium fluoroalkylsufonimides, lithium fluoroarylsufonimides, lithium bis(oxalate borate), lithium tris(trifluoromethylsulfonylimide)methide, lithium tetrafluoroborate, lithium perchlorate, lithium tetrachloroaluminate, lithium chloride, or a combination thereof.

In one embodiment, the sodium salt includes sodium trifluoromethanesulfonate, NaClO₄, NaPF₆, NaBF₄, NaTFSI (sodium(I) Bis(trifluoromethanesulfonyl)imide), NaFSI (sodium(I) Bis(fluorosulfonyl)imide), or a combination thereof.

In one embodiment, the Mg salt includes magnesium trifluoromethanesulfonate, Mg(ClO₄)₂, Mg(PF₆)₂, Mg(BF₄)₂, Mg(TFSI)₂ (magnesium(II) Bis(trifluoromethanesulfonyl)imide), Mg(FSI)₂ (magnesium(II) Bis(fluorosulfonyl)imide), or a combination thereof.

In one embodiment, the Zn salt includes zinc trifluoromethanesulfonate, Zn(ClO₄)₂, Zn(PF₆)₂, Zn(BF₄)₂, Zn(TFSI)₂ (zinc(II) Bis(trifluoromethanesulfonyl)imide), Zn(FSI)₂ (zinc(II) Bis(fluorosulfonyl)imide), or a combination thereof.

In one embodiment, the support matrix comprises poly-propylene (PP), poly-ethylene (PE), glass fiber (GF), polyethylene oxide (PEO), polyvinylidene fluoride (PVDF), polytetrafluoroethylene (PTFE), polyallylamine (PAH), polyurethane, polyacrylonitrile (PAN), polymethylmethacrylate (PMMA), polytetraethylene glycol diacrylate, or copolymers thereof.

In one aspect of the invention, a method for fabricating a composite electrolyte membrane usable for ionic conductor for an electrochemical device includes incorporating metal-organic frameworks (MOFs) into a support matrix, wherein the MOFs are a class of crystalline porous solids constructed from metal cluster nodes and organic linkers, and wherein support matrix is adapted to function as at least one of a mechanical support, a fire retardant, and an electronic blocking layer; and introducing or impregnating a liquid electrolyte in the MOFs to form ion channels that facilitates fast movements of cations, wherein the liquid electrolyte is selected to function as an electrolyte modulator to immobilize anions and liberate cations.

In one embodiment, the incorporating step is performed by coating, lamination, physical mixing and press, in situ growth or polymerization.

In one embodiment, the MOF material is firstly mixed with the support matrix in a solvent to form a slurry, the formed slurry is then coated on one side or both sides of a separator, and the resulting hybrid separator is further soaked in the liquid electrolyte to form the ion channels.

In one embodiment, the MOF material is blended with the support matrix to form a freestanding and flexible thin membrane, and the freestanding and flexible thin membrane is directly attached on one side or both sides of a separator followed by soaking the resulting hybrid separator in the liquid electrolyte to form the ion channels.

In one embodiment, the support matrix is soaked in a MOF precursor solution including metal salts, ligands and solvents, followed by a heat treatment, to form a MOF and support matrix hybrid membrane, and the resulting hybrid membrane is activated and soaked in a liquid electrolyte to form the ion channels.

In one embodiment, the MOFs have open metal sites (OMS) created by activating pristine MOFs to remove guest molecules or partial ligands thereof.

In a further aspect of the invention, an electrochemical device has ionic conductor. The ionic conductor comprises the composite electrolyte membrane as disclosed above.

These and other aspects of the present invention will become apparent from the following description of the preferred embodiment taken in conjunction with the following drawings, although variations and modifications therein may be affected without departing from the spirit and scope of the novel concepts of the invention.

### BRIEF DESCRIPTION OF THE DRAWINGS

The accompanying drawings illustrate one or more embodiments of the invention and together with the written description, serve to explain the principles of the invention. Wherever possible, the same reference numbers are used throughout the drawings to refer to the same or like elements of an embodiment.

FIG. 1A shows a scheme of a metal organic framework (MOF) material HKUST-1, made from copper and benzene tricarboxylic acid (BTC) ligands, which forms a rigid framework with 1.1 nm pore diameters, according to one embodiment of the invention.

FIG. 1B shows a schematic, perspective view of the HKUST-1 framework with ionic channels and solvated ions within the ionic channels, according to one embodiment of the invention.

FIG. 1C shows a cross view of the HKUST-1 framework with the ionic channels showing the binding of ClO₄⁻ to the open copper sites and the free, solvated Li⁺ ions within the ionic channels, according to one embodiment of the invention.

FIG. 2 shows schematically a representative electrolyte structure constructed by laminating or coating a MOF layer on a separator, according to one embodiment of the invention.

FIG. 3 shows schematically a representative electrolyte structure constructed by in-situ growth of the MOF within a porous separator membrane, according to one embodiment of the invention.

FIG. 4 shows X-ray diffraction (XRD) patterns of UiO66-NH₂ glass fiber (GF) composite membrane (denoted as UiO66-NH₂@GF), according to one embodiment of the invention.

FIGS. 5A and 5B respectively show scanning electron microscopy (SEM) images of an in-plane view and a cross-section view of a GF membrane.

FIGS. 5C and 5D respectively show SEM images of an in-plane view and a cross-section view of a MOF-GF (denoted as MOF@GF) composite membrane, according to embodiments of the invention.

FIG. 6 shows cationic transference number measurements using direct circuit (DC) polarization of the MOF@GF electrolyte membrane (inset: alternating circuit impedance before and after DC polarization), according to embodiments of the invention.

FIG. 7 shows LiFePO₄ half-cell cycling performance using liquid electrolyte saturated PP (Celgard polypropylene 3401), GF and the UiO66-NH₂@GF electrolyte membrane under current density of 1 C (about 2.5 mA cm⁻²), according to embodiments of the invention.

FIG. 8 shows LiFePO₄|Li₄Ti₅O₁₂ full cell cycling performance using liquid electrolyte saturated PP (Celgard polypropylene 3401), GF and the UiO66-NH₂@GF electrolyte membrane under current density of 0.5 C (about 4 mA cm⁻²), according to embodiments of the invention.

### DESCRIPTION OF EMBODIMENTS

The invention will now be described more fully hereinafter with reference to the accompanying drawings, in which exemplary embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art. Like reference numerals refer to like elements throughout. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more”. The word “exemplary” is used herein to mean “serving as an example, instance, or illustration”. Any aspect described herein as “exemplary” is not necessarily to be construed as preferred or advantageous over other aspects. Unless specifically stated otherwise, the term “some” refers to one or more. Combinations such as “at least one of A, B, or C”, “one or more of A, B, or C”, “at least one of A, B, and C”, “one or more of A, B, and C”, and “A, B, C, or any combination thereof” include any combination of A, B, and/or C, and may include multiples of A, multiples of B, or multiples of C. Specifically, combinations such as “at least one of A, B, or C”, “one or more of A, B, or C”, “at least one of A, B, and C”, “one or more of A, B, and C”, and “A, B, C, or any combination thereof” may be A only, B only, C only, A and B, A and C, B and C, or A and B and C, where any such combinations may contain one or more member or members of A, B, or C. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. The words “module”, “mechanism”, “element”, “device” and the like may not be a substitute for the word “means”. As such, no claim element is to be construed as a means plus function unless the element is expressly recited using the phrase “means for”. It should also be understood that one or more steps within a method may be executed in different order (or concurrently) without altering the principles of the invention.

The terms used in this specification generally have their ordinary meanings in the art, within the context of the invention, and in the specific context where each term is used. Certain terms that are used to describe the invention are discussed below, or elsewhere in the specification, to provide additional guidance to the practitioner regarding the description of the invention. For convenience, certain terms may be highlighted, for example using italics and/or quotation marks. The use of highlighting has no influence on the scope and meaning of a term; the scope and meaning of a term are the same, in the same context, whether or not it is highlighted. It will be appreciated that the same thing can be said in more than one way. Consequently, alternative language and synonyms may be used for any one or more of the terms discussed herein, nor is any special significance to be placed upon whether or not a term is elaborated or discussed herein. Synonyms for certain terms are provided. A recital of one or more synonyms does not exclude the use of other synonyms. The use of examples anywhere in this specification including examples of any terms discussed herein is illustrative only, and in no way limits the scope and meaning of the invention or of any exemplified term. Likewise, the invention is not limited to various embodiments given in this specification.

It will be understood that when an element is referred to as being “on” another element, it can be directly on the other element or intervening elements may be present therebetween. In contrast, when an element is referred to as being “directly on” another element, there are no intervening elements present. As used herein, the term “and/or” includes any and all combinations of one or more of the associated listed items.

It will be understood that, although the terms first, second, third, etc. may be used herein to describe various elements, components, regions, layers and/or sections, these elements, components, regions, layers and/or sections should not be limited by these terms. These terms are only used to distinguish one element, component, region, layer or section from another element, component, region, layer or section. Thus, a first element, component, region, layer or section discussed below can be termed a second element, component, region, layer or section without departing from the teachings of the invention.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising”, or “includes” and/or “including” or “has” and/or “having” when used in this specification specify the presence of stated features, regions, integers, steps, operations, elements, and/or components, but do not preclude the presence or addition of one or more other features, regions, integers, steps, operations, elements, components, and/or groups thereof.

Furthermore, relative terms, such as “lower” or “bottom” and “upper” or “top”, may be used herein to describe one element's relationship to another element as illustrated in the figures. It will be understood that relative terms are intended to encompass different orientations of the device in addition to the orientation shown in the figures. For example, if the device in one of the figures is turned over, elements described as being on the “lower” side of other elements would then be oriented on “upper” sides of the other elements. The exemplary term “lower” can, therefore, encompass both an orientation of “lower” and “upper”, depending on the particular orientation of the figure. Similarly, if the device in one of the figures is turned over, elements described as “below” or “beneath” other elements would then be oriented “above” the other elements. The exemplary terms “below” or “beneath” can, therefore, encompass both an orientation of above and below.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

As used herein, “around”, “about”, “substantially” or “approximately” shall generally mean within 20 percent, preferably within 10 percent, and more preferably within 5 percent of a given value or range. Numerical quantities given herein are approximate, meaning that the term “around”, “about”, “substantially” or “approximately” can be inferred if not expressly stated.

As used herein, the terms “comprise” or “comprising”, “include” or “including”, “carry” or “carrying”, “has/have” or “having”, “contain” or “containing”, “involve” or “involving” and the like are to be understood to be open-ended, i.e., to mean including but not limited to.

The description is now made as to the embodiments of the invention in conjunction with the accompanying drawings. Various modifications to these aspects will be readily apparent to those skilled in the art, and the generic principles defined herein may be applied to other aspects. In accordance with the purposes of this invention, as embodied and broadly described herein, this invention relates to a composite electrolyte membrane, and fabrication methods and applications of the same.

In one aspect of the invention, the composite electrolyte membrane in one embodiment comprises an alkali metal liquid electrolyte, a support matrix and metal-organic frameworks (MOFs), which can be used as ionic conductor for electrochemical device. The support matrix serves either for a mechanical support, a fire retardant and/or an electronic blocking layer. The liquid electrolyte impregnated porous metal-organic framework functions as an electrolyte modulator to immobilize anion as well as to liberate cation. The enhanced cationic transport number benefits not only electrochemical performances but also improves the thermal stability. In certain configuration, the combination approaches of the support matrix and the MOF can be coating, lamination, physical mixing and press, in situ growth or polymerization.

In the certain embodiments, the electrolyte modulator having ion/ionic-channels are formed from biomimetic metal-organic frameworks (MOFs). The open metal sites (OMS) of the MOFs are created by activating pristine MOFs to remove guest molecules or partial ligands. Through introducing (impregnating) binary liquid electrolyte, the polarized OMS is capable of bonding anion and thus forming anion-decorated ion channels. The resulting solid-like or semi-solid electrolyte structure is considered as a negatively charged framework, which facilitates relative fast movements of cations within the channels. If the electrolyte structure were flooded with liquid electrolyte, it is regarded as a gel electrolyte. If liquid electrolyte dominates (MOF: liquid electrolyte<0.5 mg/ul) the whole electrolyte structure, the MOFs are considered as electrolyte additive.

In the certain embodiments, the electrolyte structure is formed by spontaneously binding electrolyte anions (e.g., ClO₄⁻, BF₄—, PF₆⁻, TFSI⁻(bis(trifluoromethane)sulfonimide), FSI⁻ (bis(fluorosulfonyl)imide), etc.) to the OMS of the MOF scaffolds. The binding constructs negatively charged channels in the pores of the MOF scaffold, which enables fast conduction of solvated ions (e.g., Li⁺, Na⁺, Mg²⁺, Zn²⁺).

For lithium-based batteries, the positive electrode is formed of LiCoO₂ (LCO) and the negative electrode is formed of lithium metal (Li). Other examples of suitable positive electrodes include LiNiMnCoO₂ (NMC), lithium iron phosphate (LiFePO₄), lithium ironfluorophosphate (Li₂FePO₄F), an over-lithiated layer by layer cathode, spinel lithium manganese oxide (LiMn₂O₄), lithium cobalt oxide (LiCoO₂), LiNi_{0.5}Mn_{1.5}O₄, lithium nickel cobalt aluminum oxide (e.g., LiNi_{0.8}Co_{0.15}Al_{0.05}O₂ or NCA), lithium vanadium oxide (LiV₂O₅), Li₂MSiO₄ (M is composed of any ratio of Co, Fe, and/or Mn), or any other suitable material that can sufficiently undergo lithium insertion and deinsertion. Other examples of suitable negative electrodes include graphite, hard or soft carbon, graphene, carbon nanotubes, titanium oxide (Li₄Ti₅O₁₂, TiO₂), silicon (Si), tin (Sn), Germanium (Ge), silicon monoxide (SiO), silicon oxide (SiO₂), tin oxide (SnO₂), transition metal oxide (Fe₂O₃, Fe₃O₄, Co₃O₄, MnₓO_{y}, etc), or any other suitable material that can undergo intercalation, conversion or alloying reactions with lithium.

For sodium, magnesium, or zinc metal batteries, suitable negative electrodes for sodium, magnesium, or zinc metal batteries include, respectively, sodium metal, magnesium metal, or zinc metal. Suitable positive electrodes for sodium metal batteries include NaMnO₂, NaFePO₄, and/or Na₃V₂(PO₄)₃. Suitable positive electrodes for magnesium metal batteries include TiSe₂, MgFePO₄F, MgCo₂O₄, and/or V₂O₅. Suitable positive electrodes for zinc metal batteries include γ-MnO₂, ZnMn₂O₄, and/or ZnMnO₂. Some or all the electrode materials can be combined with MOF electrolyte in order to achieve better ion transport throughout the electrode layers.

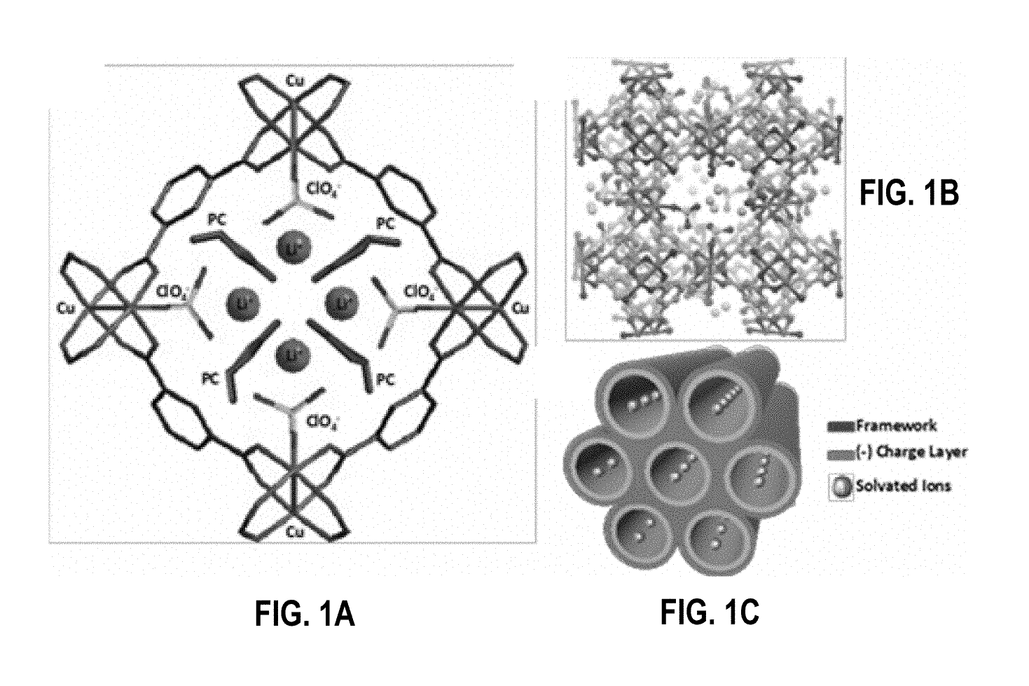

Metal organic frameworks (MOFs) are a class of crystalline porous solids constructed from metal cluster nodes and organic linkers. The synthetic procedures of MOF typically involve hydrothermal method, as-prepared MOF pore channels are usually occupied by guest species (e.g. solvent molecules, like water or dimethylformamide). The removal of solvent species by activation creates vacant spaces to accommodate guest binary electrolyte. The colossal candidates of MOF are of particular interest due to their various metal centers, ligand derivatives and corresponding topology. As exemplified by HKUST-1 (i.e., an MOF), which constructed from Cu (II) paddle wheels and 1, 3, 5-benzenetricarboxylates (BTC) linkers. More specifically, FIGS. 1A-1C illustrates a 2-dimensional unit cell of HKUST-1, where HKUST-1 possesses three-dimensional pore channels with a pore diameter of 1.1 nm. The three spheres represent the various pore sizes within the framework of the unit cell.

Table 1 lists examples of the MOFs that are used as the channel scaffolds with pore size ranging from 1.1 nm to 2.9 nm, containing metal centers from the p-block (Al and In) and from the d-block (Cu, Fe, and Mn), as well as different ligands (BTC, benzene-1,4-dicarboxylic acid (BDC), isonicotinic acid (IN), and azobenzene-4,4′-dicarboxylic acid (ADC)).

TABLE 1
Examples of the MOFs.

| MOFs | Formula | Ligand structure | Pore size |
|---|---|---|---|
| HKUST-1 Mil-100-Al Mil-100-Fe | Cu₃(BTC)₂ Al₃O(OH)(BTC)₂ Fe₃O(OH)(BTC)₂ | 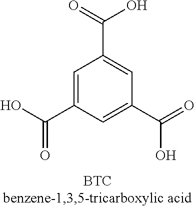 [SMILES: O=C(O)c1cc(C(=O)O)cc(C(=O)O)c1] | 1.1 nm 2.9 nm 2.9 nm |
| MOF-73 | Mn₃(BDC)₃ | 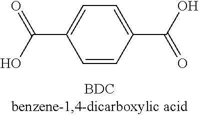 [SMILES: O=C(O)c1ccc(C(=O)O)cc1] | 1.1 nm |
| In-MOF | (In₃O)(OH)(ADC)₂(IN)₂ | 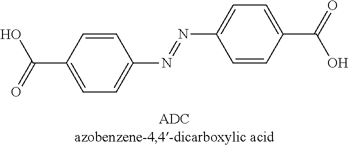 [SMILES: O=C(O)c1ccc(/N=N/c2ccc(C(=O)O)cc2)cc1] | 2.3 nm |
| | | 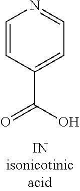 | |

In certain embodiments, the MOF material selection is also based on the stability of the MOFs in the battery electrochemical environment. The judicious selection of the metal centers and organic linkers (ligands) affords the synthesis of over 20,000 MOFs with designable functionalities and pore channels. In certain embodiments, MOFs with mesopore structures are synthesized by using a large ligand. In one embodiment, the MOF with a mesopore structure is the mesoprous In-MOF. In certain embodiments, MOFs with more surface functional groups for coordinating liquid electrolytes are also used. In certain embodiments, other examples of suitable MOF materials include, but are not limited to, Mil-100 such as Mil-100-Al and Mil-100-Fe in listed Table 1, mesoprous In-MOF, and the like. It should be appreciated that any MOF can be used to practice this invention.

In certain embodiments, the MOFs are synthesized in the presence of a solvent (e.g., water) and the ligands, both of which coordinate with the MOF's metal centers. Removal of the solvent molecules (e.g., at an elevated temperature under vacuum) breaks the solvent coordination from the MOFs, resulting in MOF scaffolds with unsaturated metal centers. The conditions for solvent molecule removal include a temperature ranging from about 200° C. to about 220° C. at a pressure of about 30 mTorr. This temperature range is suitable for removing any solvent, although it is to be understood that high boiling point solvent may require longer evacuation times than low boiling point solvents. In an example, the powder form MOF material is degassed or activated under vacuum at a high/elevated temperature (e.g., from about 200° C. to about 220° C.) to remove absorbed water molecules. It should be appreciated that other solvent molecule removal methods may also be used in the invention.

Table 2 shows another serial example of MOFs. UiO-66 stands for Zirconium MOF with perfect stoichiometry of [Zr₆O₄OH₄][C₆H₄(COO)₂]₆. Its typical synthetic route is hydrothermal reactions between ZrCl₄ with terephthalic acid (BDC) in a polar (hydrophilic) aprotic solvent of dimethylformamide (DMF). Zr⁴⁺ is gradually hydrolyzed to form a six-center octahedral metal cluster with the assistance from basicity of DMF. The faces of metal cluster octahedron are capped with eight oxygens, of which four are protonated to balance the charge. The cationic Zr₆O₄OH₄ are bridged by terephthalate, the resulting three-dimensional frameworks possess tetrahedral and octahedral microporous cages of 7.5 to 12 Å. Another isostructural material UiO-67 can be obtained by replacing the terephthalic acid (BDC) with longer linker of 4,4′-biphenyldicarboxylic acid (BPDC). The consequent pore size expands from 7.5 and 12 Å to 12 and 16 Å, respectively. Both UiO-66 and UiO-67 share almost identical Zirconium metal octahedron, it undergoes a dehydration by removal of two water molecules from the cages, thus creating partially open metal sites as well as local polarized framework surface.

Several derivatives of these MOFs have been synthesized with linker possessing functional groups such as amines, halogens, hydroxyls or nitros, as enclosed herein at Table 2. The vast diversity of functional side groups is believed to introduce desirable properties for the MOF as solid electrolyte, like higher ionic conductivity, higher transference number and superior stability against reactive alkali metals. For instance, electron donor/acceptor properties of side groups would impact the acidity of benzene carboxylate, thus shift the charge balance of overall metal organic framework and resulting anion adsorption capability. In addition, self-sacrificial decomposition of nitrogen or halogen containing groups from MOF ligand in contact with lithium would generate solid-state interface (SEI) comprising lithium nitrate or lithium halogen, which are well known to be good lithium conductor and protector of lithium from continuous consumptive reaction with liquid electrolyte.

TABLE 2
Examples of MOFs

| Zirconium-based | | |
|---|---|---|
| MOF | Ligand | |
| UiO-66 | Terephthalic acid (BDC) | 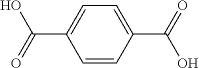 [SMILES: O=C(O)c1ccc(C(=O)O)cc1] |
| UiO-67 | 4,4′-biphenyldicarboxylic acid (BPDC) | 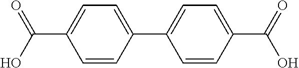 [SMILES: O=C(O)c1ccc(-c2ccc(C(=O)O)cc2)cc1] |
| UiO-66-NH₂ | 2-Aminoterephthalic acid (NH₂—BDC) | 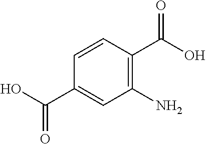 [SMILES: Nc1cc(C(=O)O)ccc1C(=O)O] |
| UiO-66-NO₂ | 2-nitroterephthalic acid (NO₂—BDC) | 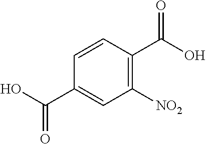 [SMILES: O=C(O)c1ccc(C(=O)O)c([N+](=O)[O-])c1] |
| UiO-66-OH | 2-Hydroxyterephthalic acid (OH—BDC) | 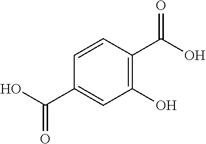 [SMILES: O=C(O)c1ccc(C(=O)O)c(O)c1] |
| UiO-66-Br | 2-Bromoterephthalic acid (Br—BDC) | 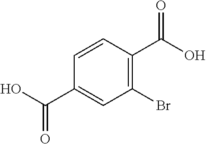 [SMILES: O=C(O)c1ccc(C(=O)O)c(Br)c1] |

During synthesis of the MOFs, surface defects are created. The surface defects of the MOF material are similar to pores in that they expose more unsaturated metal centers to coordinate salt anions. Therefore, the pores inside of the MOF material, as well as the defects resulting from the packing of the MOF materials, can become ion transportation channels. As for UiO-66 series MOFs, metal vs ligand ratio, synthetic temperature, hydrochloric acid as well as incorporation of mono/di-carboxylic acid were manipulated to tune the MOF defects sites. For instance, trifluoroacetic acid, trichloroactic acid, formic acid, acetic acid, pivalic acid, benzoic acid, and stearic acid, etc. are effective in creating massive missing ligands by replacement of terephthalic acid and decomposition upon activation, thus resulting MOFs possess defective structure and abundant sites for coordinating anions. These defects throughout the frameworks are also classified as immobilization sites for anion and transport facilitator for cations.

The activated MOF material powder is combined with, and is soaked in, a non-aqueous liquid electrolyte composed of metal salt(s) dissolved in non-aqueous solvent(s). The non-aqueous liquid electrolyte solvent(s) are ethylene carbonate (EC), propylene carbonate (PC), vinylene carbonate (VC), fluoroethylene carbonate (FEC), butylene carbonate (BC), dimethyl carbonate (DMC), diethyl carbonate (DEC), ethylmethyl carbonate (EMC), methylpropyl carbonate (MPC), butylmethyl carbonate (BMC), ethylpropyl carbonate (EPC), dipropyl carbonate (DPC), cyclopentanone, sulfolane, dimethyl sulfoxide, 3-methyl-1,3-oxazolidine-2-one, γ-butyrolactone, 1,2-di-ethoxymethane, tetrahydrofuran, 2-methyltetrahydrofuran, 1,3-dioxolane, methyl acetate, ethyl acetate, nitromethane, 1,3-propane sultone, γ-valerolactone, methyl isobutyryl acetate, 2-methoxyethyl acetate, 2-ethoxyethyl acetate, diethyl oxalate, or an ionic liquid, chain ether compounds such as gamma butyrolactone, gamma valerolactone, 1,2-dimethoxyethane, and diethyl ether, cyclic ether compounds such as tetrahydrofuran, 2-methyltetrahydrofuran, 1,3-dioxolane, and dioxane, and mixtures of two or more of these solvents. The polarity of the non-aqueous solvent(s) is selected to match the surface properties of the MOF material.

The metal salt dissolved in the liquid electrolyte solvent is a lithium salt, a sodium salt, a magnesium (Mg) salt, and/or a zinc (Zn) salt. Examples of suitable lithium salts include lithium hexafluorophosphate, lithium hexafluoroarsenate, lithium bis(trifluoromethlysulfonylimide) (LiTFSI), lithium bis(trifluorosulfonylimide), lithium trifluoromethanesulfonate, lithium fluoroalkylsufonimides, lithium fluoroarylsufonimides, lithium bis(oxalate borate), lithium tris(trifluoromethylsulfonylimide)methide, lithium tetrafluoroborate, lithium perchlorate, lithium tetrachloroaluminate, lithium chloride, and combinations thereof. Examples of suitable sodium salts include sodium trifluoromethanesulfonate, NaClO₄, NaPF₆, NaBF₄, NaTFSI (sodium(I) Bis(trifluoromethanesulfonyl)imide), NaFSI (sodium(I) Bis(fluorosulfonyl)imide), and the like. Examples of suitable Mg salts include magnesium trifluoromethanesulfonate, Mg(ClO₄)₂, Mg(PF₆)₂, Mg(BF₄)₂, Mg(TFSI)₂ (magnesium(II) Bis(trifluoromethanesulfonyl)imide), Mg(FSI)₂ (magnesium(II) Bis(fluorosulfonyl)imide), and the like. Examples of suitable Zn salts include zinc trifluoromethanesulfonate, Zn(ClO₄)₂, Zn(PF₆)₂, Zn(BF₄)₂, Zn(TFSI)₂ (zinc(II) Bis(trifluoromethanesulfonyl)imide), Zn(FSI)₂ (zinc(II) Bis(fluorosulfonyl)imide), and the like. The metal salt is selected to have a suitably sized anion, which depends, at least in part, upon the MOF material that is used. The anion size is selected to ensure that the salt can infiltrate into at least some of the MOF pores, and then become immobilized therein to form the ionic conducting channel.

The activated MOF is combined with the liquid electrolyte in a weight ratio ranging from about 10:1 to about 1:1000. The uniformity of combined electrolyte can be achieved by heating, stirring, evacuating, sonicating or aging. The MOF material is soaked in the liquid electrolyte for around one week, at room temperature. Soaking the degassed or activated MOFs in liquid electrolyte (e.g., LiClO₄ in propylene carbonate (PC)) allows the anions (e.g., ClO₄⁻) of the metal salt to bind to the unsaturated metal sites of the MOF and spontaneously form anion-bound MOF channels. In other words, the anions are bound to metal atoms of the MOF such that the anions are positioned within the pores of the MOF. After formation, the negatively charged MOF channels are ion transport channels that allow for effective transport of the solvated cations (e.g., PC-solvated Li⁺ or Na⁺ or Zn²⁺ or Mg²⁺). The solvated cations may hop through and/or between the plurality of negatively charged MOF channels. More particularly, the solvated cations can transfer within and/or between the channels by hopping among each of the anions and/or solvents. In the pores, composed by the MOF units, the cations transfer with the help of the solvent.

The mechanical support matrix, exemplified here but not limited to, is poly-propylene (PP), poly-ethylene (PE), glass fiber (GF), polyethylene oxide (PEO), polyvinylidene fluoride (PVDF), polytetrafluoroethylene (PTFE), polyallylamine (PAH), polyurethane, polyacrylonitrile (PAN), polymethylmethacrylate (PMMA), polytetraethylene glycol diacrylate, copolymers thereof. The polymer or inorganic backbones can work as 1) electronic blocking layer; 2) protector of thermal runaway and reinforcement of mechanical strength, for example, glass fiber (GF) composed of fibrous inorganic oxides (SiO₂) possesses superior thermal stability (about 500° C.), mechanical strength and cost advantages over polyolefin separators.

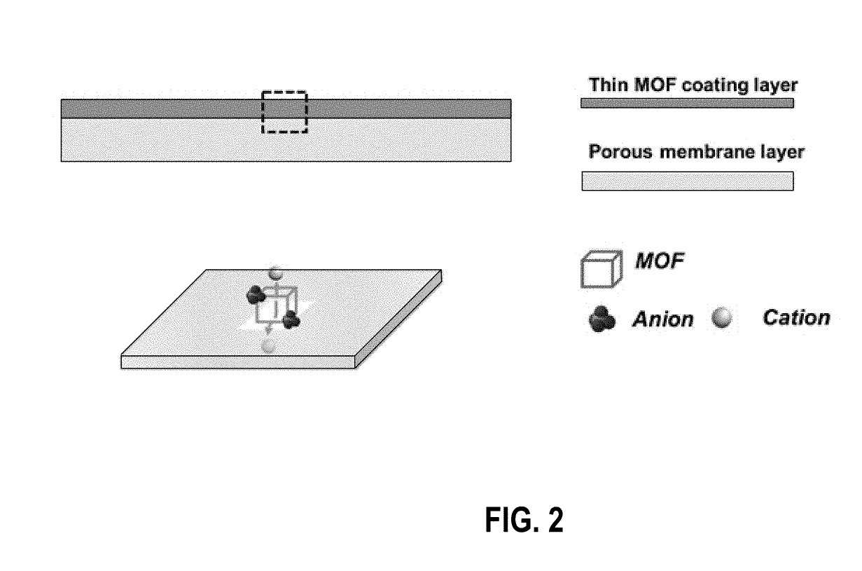

The steric relationships between the support matrix and the MOF exemplified here but not limited to coating, lamination, physical mixing and press, in situ growth or polymerization. For example, in one embodiment as show in FIG. 2, the activated MOF solids are firstly mixed with a polymeric binder, e.g., PVDF, in a solvent and the resulting slurry can be coated on conventional separators. In certain embodiments, the coating of the MOF can either by one-side or on both sides of the separators. The resulting hybrid separator is further soaked in an electrolyte to form biomimetic ion-channels. Another alternative way of combining the two layers is by lamination, a freestanding MOF membrane can be prepared by blending activated MOF solids with polytetrafluoroethylene (PTFE), a free-standing and flexible thin membrane can be directly attached on the separator followed by soaking of hybrid membrane in liquid electrolyte. The separator can face the metal anode side due to its electronic blocking property, this configuration can be used in metal batteries when contact stability of the MOF towards lithium is not satisfactory.

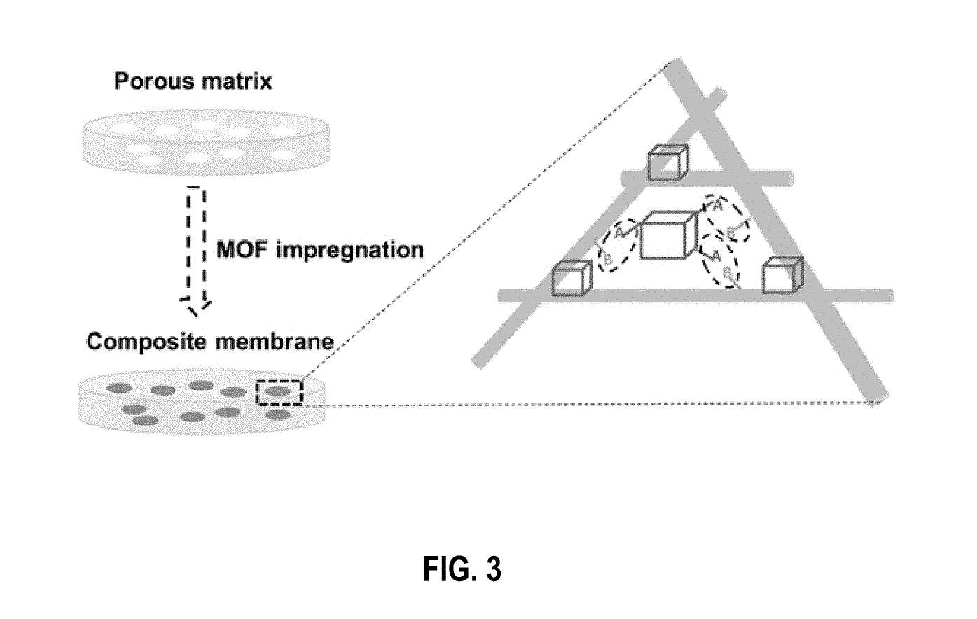

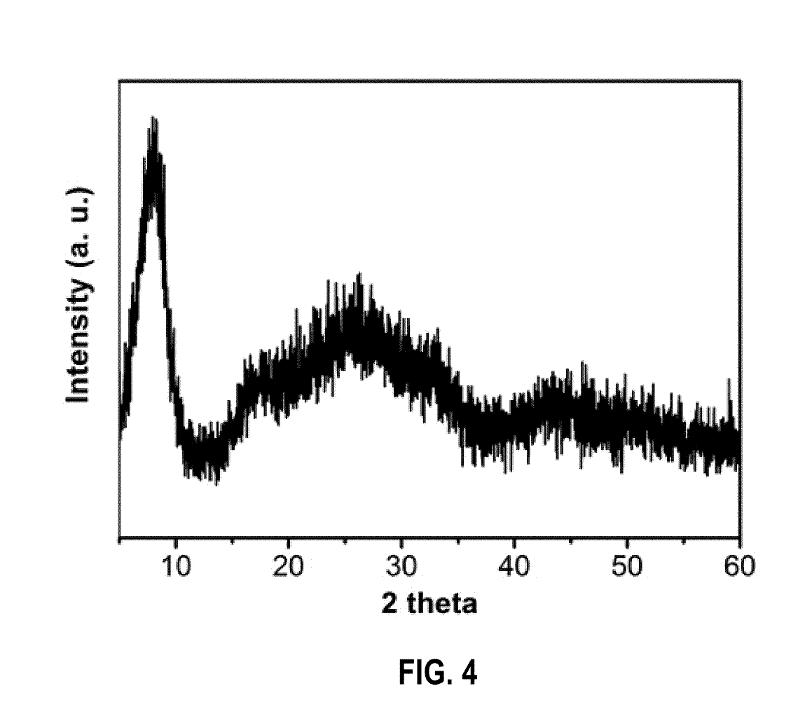

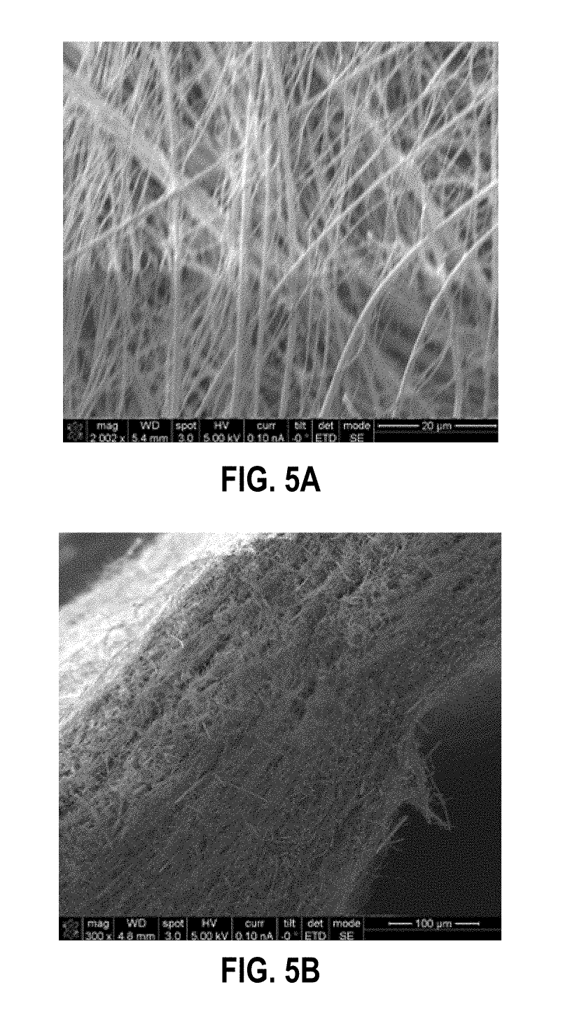

Another approach is exemplified in FIG. 3, the incorporation of the MOF into a porous glass fiber (GF) membrane (denoted as MOF@GF composite membrane) is by a facile in-situ synthesis method. First, the MOF@GF composite membrane can be easily obtained by soaking the GF in a MOF precursor solution (including metal salt, ligand and solvent), followed by a heat treatment. The preferable precipitations of the MOF on the GF is expected due to abundant hydroxyl species (—OH) on organic backbones of the GF, which favorably interact with dangling carboxylic acid (—COOH) groups in the MOF during synthesis. The resulting MOF@GF hybrid membranes are activated and soaked in a liquid electrolyte in a similar manner like foregoing preparation of composite membranes.

According to the invention, the foregoing MOF porous solids serve as an electrolyte modulator, transforming ionic chemistry of electrolyte by immobilizing anion and facilitating cation transport. The polarization induced by anion movements is reduced and the resulting modified electrolyte is projected to benefit from following advantages:

1) As for rechargeable lithium batteries, the restricted movements of anions give rise to the enhanced cation transference number and therefore the improved power capability.

2) Parasitic reactions involving anions are mitigated, thereby postulating the prolonged cycle life. The MOF electrolyte modulator can also be applied to lithium metal batteries.

3) Incorporation of solid MOFs helps with mechanical and thermal stability.

4) Alleviated interfacial resistance either from self-healing decomposition of ligands or from tunable surface area/particle size of MOFs assists in eliminating metallic dendrites.

Without intent to limit the scope of the invention, examples and their related results according to the embodiments of the present invention are given below. These examples, however, should not in any sense be interpreted as limiting the scope of the present invention.

The MOF-GF membranes were prepared by a facile in-situ growth of a MOF within a GF porous scaffold by infiltration of MOF precursors and subsequent heat treatment. The UiO-66-NH₂ precursor solution was prepared by dissolving about 30 mmol 2-amino-terephthalic acid (NH₂—BDC) and about 30 mmol ZrCl₄ into about 20 mL dimethylformamide (DMF) in a microwave quartz tube. After rigorously stirring for about 30 minutes, commercial glass fiber membranes (Borosilicate, GF/C, Whatman, 18 mm diameters) were soaked in foregoing precursor solution for about 30 minutes under vacuum. The wetting and penetration of the precursor solution into the porous GF membrane can be determined by transition of appearance from pale white to semi-transparent. It was further sent for microwave treatment (800 W) under about 140° C. for about 1 hour, the preferential precipitation of bright yellow solids on the GF membrane was overserved and resulting composite membranes were thoroughly washed with DMF/ethanol for multiple times and dried afterwards under about 80° C. for about 24 hours.

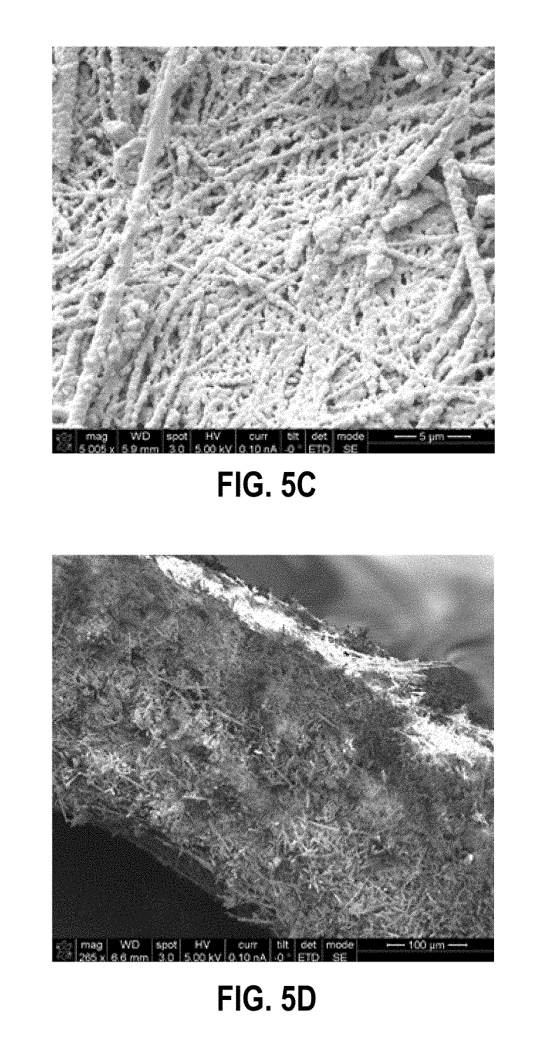

As shown in FIG. 4, the crystal structure was determined by X-ray diffraction pattern, all peaks were indexable to amorphous phase for UiO66-NH₂. The morphology and particle sizes were examined by scanning electron spectroscopy (SEM), as shown in FIGS. 5A-5D, the borosilicate GF membrane includes high aspect ratio fibers (length over diameter ratio>40) and microsized pores with thickness of about 250 um. The MOF-GF composite membrane (denoted as MOF@GF), massive microsized MOF on crosslinked GF and consequent sub-microsized pores were confirmed. No appreciable thickness expansion was observed. Preferable growth of the MOF on the GF owing to affinity between abundant hydroxylic group (—OH) from glass and carboxylic group (—COOH) from MOF ligands (NH₂—BDC), fibrous voids can be readily filled up by manipulating synthetic conditions.

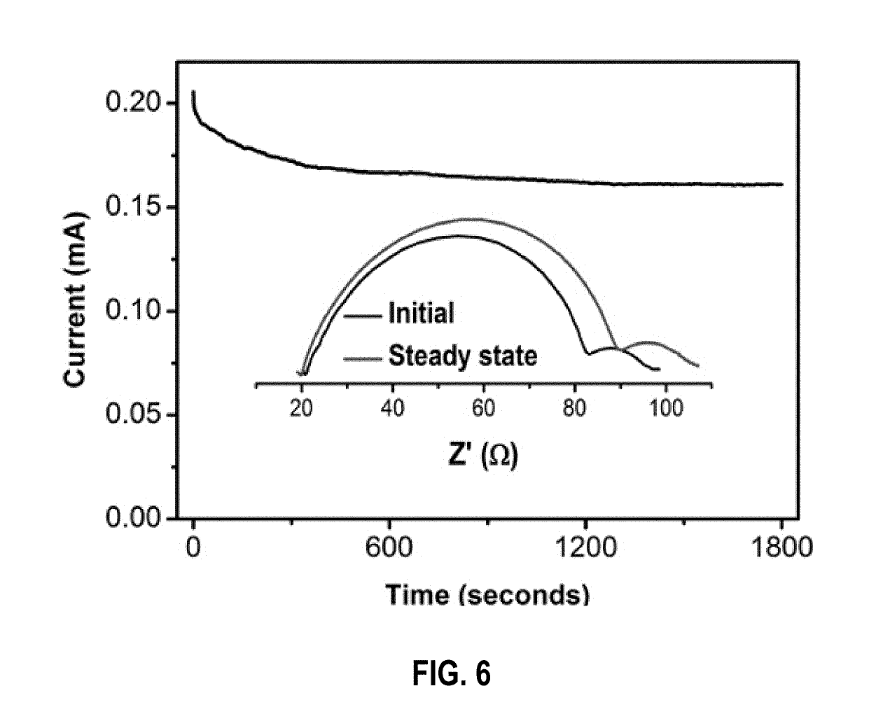

The as-prepared MOF@GF membranes were activated at about 180° C. for about 24 hours under vacuum and further soaked in 1M LiClO₄|PC (with about 5 wt % fluoroethylene carbonate, FEC) liquid electrolyte for about another 24 hours. The soaked composite membranes were wiped off by tissues to remove excessive liquid electrolyte on membrane surface. The evaluation of transference number was conducted by sandwiching foregoing composite membrane between two lithium disks, which employ a combination of alternating circuit (AC) impedance and direct circuit (DC) polarization approach. The AC polarization was initially carried out using amplitude of about 20 mV and frequency range from about 1 Mhz to 0.1 hz, the subsequent potentiostatic polarization of about 20 mV was performed for 30 minutes till the current response along with the time reaching a steady state. Eventually a second AC polarization was conducted to monitor the impedance evolution after the DC polarization. The cell rested for half hour and the whole sets of experiments were repeated. As shown in FIG. 6, the AC impedances exhibit semi-circle where the initial point represent the bulk resistance of electrolyte and the end point stands for the interfacial/charge transfer resistance between electrolyte and lithium electrode, which followed by a tail indicating diffusion process of Li⁺ to lithium electrodes. The interfacial resistance was deducted from the overall voltage applied as proposed by Evans Bruce method. The calculated lithium transference number (t_{Li}⁺) is as high as about 0.67, which almost double the lithium transport number as for liquid electrolyte reported in literature. The incorporation of MOF into GF scaffold significantly enhances the t_{Li}⁺ by two folds, which is consistent with our proposed mechanism that MOFs are capable of immobilizing relative free anion (ClO₄⁻) and facilitating transport of cation (Li⁺). The improvement of cationic transference number in lithium ion rechargeable batteries is of great significance due to large polarization loss and side reactions from free migration of anions in conventional liquid electrolyte (t_{Li}⁺ about 0.3).

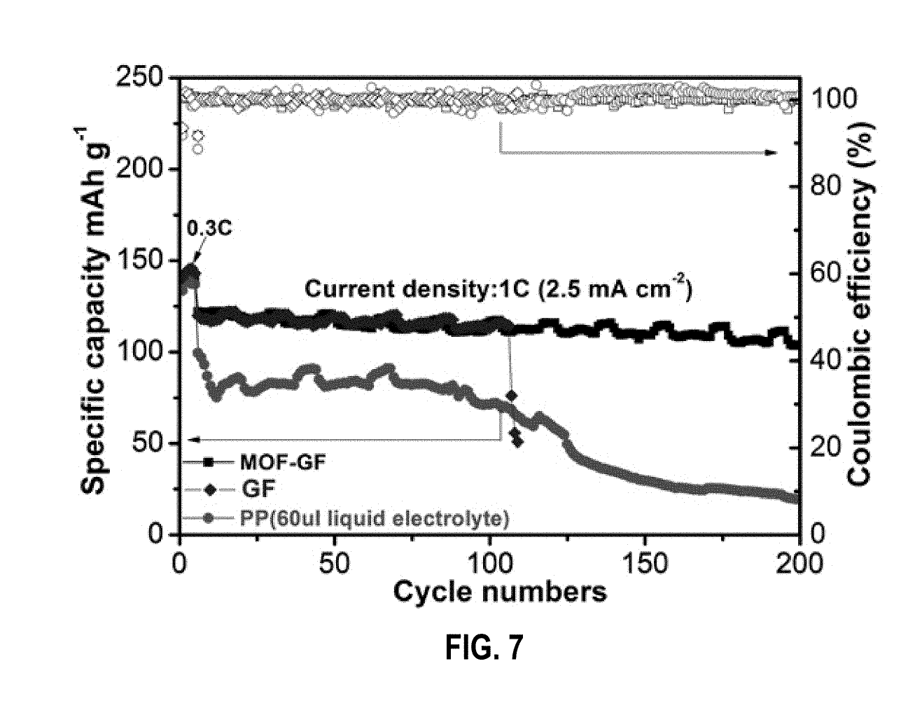

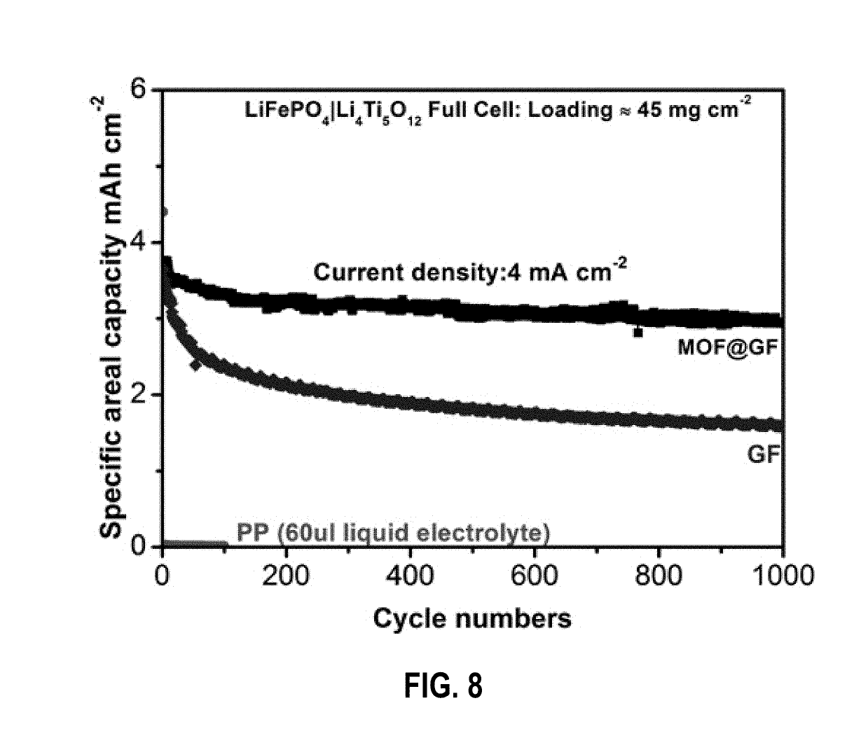

To illustrate the superiority of composite electrolyte membrane compared with tradition liquid electrolyte, we fabricate LiFePO₄ half-cells (Li metal as anode) and LiFePO₄ (cathode)|Li₄Ti₅O₁₂(anode) full cells for demonstrative purposes. FIG. 7 compares half-cells cycling performance using liquid electrolyte saturated PP (Celgard polypropylene 3401), GF and UiO66-NH₂@GF electrolyte membrane (denoted as PP, GF and MOF@GF, respectively). Here cathode loading of LiFePO₄ is about 20 mg cm⁻² and 5 initial cycling were performed at 0.3 C and at 1 C (about 2.5 mA cm⁻²) for subsequent cycles. The MOF@GF electrolyte can afford 86% capacity retention for about 200 charge/discharge cycles at current density of about 2.5 mA cm⁻². In sharp contrast, the blank GF infused with liquid electrolyte exhibits abrupt capacity decline at 108^{th} cycle, showing cell failure induced by lithium dendrite. This phenomenon can be interpreted by the large microsized pores in fibrous networks, which is not suitable for blocking nanostructured lithium dendrite. Compared with bare GF, PP possess smaller pore sizes of about 100 nm, nevertheless only about 20% capacity can be maintained at about 200 cycles, which corresponds to a drastic capacity decay of about 0.4% per cycle. The large capacity loss can be attributed to depletion of liquid electrolyte from massive formation of lithium dendrites. The overall cycling performance at about 2.5 mA cm⁻² demonstrate that MOF@GF can not only effectively block lithium dendrite but also mitigate polarization and reduce parasitic reactions. To exclude the impact of lithium metal deteriorations, we conducted full cell tests based on LiFePO₄|Li₄Ti₅O₁₂ configuration and identical sets of electrolyte (PP, GF and MOF@GF). In all tests, the anode and cathode mass loading is controlled at about 45 mg cm⁻² and current density is about about 0.5 C (4 mA cm⁻²) for consistence. As plotted in FIG. 8, PP shows almost no capacity at high current density of about 4 mA cm⁻² which might due to severe polarization from thick electrodes and low transference number of liquid electrolyte. However, MOF@GF deliver about 80% capacity retention at 1000 cycles. As a reference, the GF only keeps about 43% of its original capacity. To conclude, the superior cycle life using MOF@GF electrolyte in full cells significantly benefit from the incorporation of MOF and corresponding higher cation transference number, which are evidenced by alleviated polarization capacity loss.

The foregoing description of the exemplary embodiments of the invention has been presented only for the purposes of illustration and description and is not intended to be exhaustive or to limit the invention to the precise forms disclosed. Many modifications and variations are possible in light of the above teaching.

The embodiments were chosen and described in order to explain the principles of the invention and their practical application so as to enable others skilled in the art to utilize the invention and various embodiments and with various modifications as are suited to the particular use contemplated. Alternative embodiments will become apparent to those skilled in the art to which the present invention pertains without departing from its spirit and scope. Accordingly, the scope of the present invention is defined by the appended claims rather than the foregoing description and the exemplary embodiments described therein.

What is claimed is:

1. A composite electrolyte membrane usable for ionic conductor for an electrochemical device, comprising:
a support matrix adapted to function as at least one of a mechanical support, a fire retardant, and an electronic blocking layer;
a material of metal-organic frameworks (MOFs), the MOFs being a class of crystalline porous solids constructed from metal cluster nodes and organic linkers, wherein the MOFs are incorporated into the support matrix by coating, lamination, physical mixing and press, in situ growth or polymerization; and
a liquid electrolyte impregnated the porous MOFs and adapted to function as an electrolyte modulator to immobilize anions and liberate cations.

2. The composite electrolyte membrane of claim 1, wherein the MOFs have open metal sites (OMS) created by activating pristine MOFs to remove guest molecules or partial ligands thereof.

3. The composite electrolyte membrane of claim 2, wherein through introducing or impregnating the liquid electrolyte, the polarized OMS is capable of bonding anions, thereby forming anion-decorated ion channels, wherein the resulting electrolyte structure is a negatively charged framework that facilitates fast movements of cations within the channels.

4. The composite electrolyte membrane of claim 3, wherein the electrolyte structure is formed by spontaneously binding electrolyte anions including ClO₄⁻, BF₄—, PF₆⁻, TFSI⁻ (bis(trifluoromethane)sulfonimide), FSI⁻ (bis(fluorosulfonyl)imide), or the like to the OMS of the MOF, wherein the binding constructs negatively charged channels in the pores of the MOF, which enables fast conduction of solvated ions.

5. The composite electrolyte membrane of claim 1, wherein each MOF contains metal centers from the p-block or the d-block, and one or more ligands of benzene-1,3,5-tricarboxylic acid (BTC), benzene-1,4-dicarboxylic acid (BDC), azobenzene-4,4′-dicarboxylic acid (ADC) and isonicotinic acid (IN).

6. The composite electrolyte membrane of claim 5, wherein the MOFs comprise Cu₃(BTC)₂, Al₃O(OH)(BTC)₂, Fe₃O(OH)(BTC)₂, Mn₃(BDC)₃, (In₃O)(OH)(ADC)₂(IN)₂, or Zirconium-based MOF including UiO-66, UiO-67, UiO-66-NH₂, UiO-66-OH, or UiO-66-Br.

7. The composite electrolyte membrane of claim 1, wherein the liquid electrolyte comprises one or more non-aqueous solvents and metal salts dissolved in the one or more non-aqueous solvents,
wherein the one or more non-aqueous solvents are selected to match the surface properties of the MOF material; and
wherein the metal salts are selected to have anions with desired sizes, which depends, at least in part, upon the MOF material, wherein the anion sizes are selected to ensure that the salts to infiltrate into at least some of the pores of the MOF, and then become immobilized therein to form the ionic conducting channels.

8. The composite electrolyte membrane of claim 7, wherein the non-aqueous liquid electrolyte solvents comprise ethylene carbonate (EC), propylene carbonate (PC), vinylene carbonate (VC), fluoroethylene carbonate (FEC), butylene carbonate (BC), dimethyl carbonate (DMC), diethyl carbonate (DEC), ethylmethyl carbonate (EMC), methylpropyl carbonate (MPC), butylmethyl carbonate (BMC), ethylpropyl carbonate (EPC), dipropyl carbonate (DPC), cyclopentanone, sulfolane, dimethyl sulfoxide, 3-methyl-1,3-oxazolidine-2-one, γ-butyrolactone, 1,2-di-ethoxymethane, tetrahydrofuran, 2-methyltetrahydrofuran, 1,3-dioxolane, methyl acetate, ethyl acetate, nitromethane, 1,3-propane sultone, γ-valerolactone, methyl isobutyryl acetate, 2-methoxyethyl acetate, 2-ethoxyethyl acetate, diethyl oxalate, an ionic liquid, chain ether compounds including at least one of gamma butyrolactone, gamma valerolactone, 1,2-dimethoxyethane and diethyl ether, cyclic ether compounds including at least one of tetrahydrofuran, 2-methyltetrahydrofuran, 1,3-dioxolane and dioxane, or a combination thereof

9. The composite electrolyte membrane of claim 7, wherein the metal salts comprise one or more of a lithium (Li) salt, a sodium (Na) salt, a magnesium (Mg) salt, and a zinc (Zn) salt,
wherein the lithium salt includes lithium hexafluorophosphate, lithium hexafluoroarsenate, lithium bis(trifluoromethlysulfonylimide) (LiTFSI), lithium bis(trifluorosulfonylimide), lithium trifluoromethanesulfonate, lithium fluoroalkylsufonimides, lithium fluoroarylsufonimides, lithium bis(oxalate borate), lithium tris(trifluoromethylsulfonylimide)methide, lithium tetrafluoroborate, lithium perchlorate, lithium tetrachloroaluminate, lithium chloride, or a combination thereof;
wherein the sodium salt includes sodium trifluoromethanesulfonate, NaClO₄, NaPF₆, NaBF₄, NaTFSI (sodium(I) Bis(trifluoromethanesulfonyl)imide), NaFSI (sodium(I) Bis(fluorosulfonyl)imide), or a combination thereof;
wherein the Mg salt includes magnesium trifluoromethanesulfonate, Mg(ClO₄)₂, Mg(PF₆)₂, Mg(BF₄)₂, Mg(TFSI)₂ (magnesium(II) Bis(trifluoromethanesulfonyl)imide), Mg(FSI)₂ (magnesium(II) Bis(fluorosulfonyl)imide), or a combination thereof; and
wherein the Zn salt includes zinc trifluoromethanesulfonate, Zn(ClO₄)₂, Zn(PF₆)₂, Zn(BF₄)₂, Zn(TFSI)₂ (zinc(II) Bis(trifluoromethanesulfonyl)imide), Zn(FSI)₂ (zinc(II) Bis(fluorosulfonyl)imide), or a combination thereof.

10. The composite electrolyte membrane of claim 7, wherein a weight ratio of the MOFs to the liquid electrolyte ranges from about 10:1 to about 1:1000.

11. The composite electrolyte membrane of claim 1, wherein the support matrix comprises poly-propylene (PP), poly-ethylene (PE), glass fiber (GF), polyethylene oxide (PEO), polyvinylidene fluoride (PVDF), polytetrafluoroethylene (PTFE), polyallylamine (PAH), polyurethane, polyacrylonitrile (PAN), polymethylmethacrylate (PMMA), polytetraethylene glycol diacrylate, or copolymers thereof.

12. An electrochemical device, comprising an ionic conductor, wherein the ionic conductor comprises the composite electrolyte membrane of claim 1.

13. A method for fabricating a composite electrolyte membrane usable for ionic conductor for an electrochemical device, comprising:
incorporating metal-organic frameworks (MOFs) into a support matrix, wherein the MOFs are a class of crystalline porous solids constructed from metal cluster nodes and organic linkers, and wherein support matrix is adapted to function as at least one of a mechanical support, a fire retardant, and an electronic blocking layer; and
introducing or impregnating a liquid electrolyte in the MOFs to form ion channels that facilitates fast movements of cations, wherein the liquid electrolyte is selected to function as an electrolyte modulator to immobilize anions and liberate cations.

14. The method of claim 13, wherein the incorporating step is performed by coating, lamination, physical mixing and press, in situ growth or polymerization.

15. The method of claim 14, wherein the MOF material is firstly mixed with the support matrix in a solvent to form a slurry, the formed slurry is then coated on one side or both sides of a separator, and the resulting hybrid separator is further soaked in the liquid electrolyte to form the ion channels.

16. The method of claim 14, wherein the MOF material is blended with the support matrix to form a freestanding and flexible thin membrane, and the freestanding and flexible thin membrane is directly attached on one side or both sides of a separator followed by soaking the resulting hybrid separator in the liquid electrolyte to form the ion channels.

17. The method of claim 14, wherein the support matrix is soaked in a MOF precursor solution including metal salts, ligands and solvents, followed by a heat treatment, to form a MOF and support matrix hybrid membrane, and the resulting hybrid membrane is activated and soaked in a liquid electrolyte to form the ion channels.

18. The method of claim 13, wherein the MOFs have open metal sites (OMS) created by activating pristine MOFs to remove guest molecules or partial ligands thereof.
